(19) United States
(12) Patent Application Publication
(10) Pub. No.: US 2018/0284875 A1
(43) Pub. Date: Oct. 4, 2018

(54) POWER CONSUMPTION REDUCTION DEVICE, POWER CONSUMPTION REDUCTION METHOD, AND POWER CONSUMPTION REDUCTION PROGRAM

(71) Applicant: NEC Corporation, Tokyo (JP)

(72) Inventor: Kenta TANAKA, Tokyo (JP)

(73) Assignee: NEC Corporation, Tokyo (JP)

(21) Appl. No.: 15/920,738

(22) Filed: Mar. 14, 2018

(30) Foreign Application Priority Data
Mar. 30, 2017 (JP) 2017-067640

(51) Int. Cl. G06F 1/32

(52) U.S. Cl. CPC G06F 1/3243

(57) ABSTRACT

A power consumption reduction device is a power consumption reduction device in which an application is operated, and includes: a processor; an output unit that is controlled by the processor in a user mode, and outputs a condition under which performance of the application is not degraded; and a determining unit that is controlled by the processor in a kernel mode, and determines a component to be operated among the components of the processor so that the output condition is satisfied.

This application is based upon and claims the benefit of priority from Japanese patent application No. 2017-067640, filed on Mar. 30, 2017, the disclosure of which is incorporated here in its entirety by reference.

### TECHNICAL FIELD

The present invention relates to a power consumption reduction device, a power consumption reduction method, and a power consumption reduction program, and more particularly, to a power consumption reduction device, a power consumption reduction method, and a power consumption reduction program that reduce power consumption of a microprocessor.

### BACKGROUND ART

A computer is equipped with a function for saving power by suspending the functions of the respective components of the computer. This function is normally called a C-state.

There are multiple levels in a C-state, such as C1, C3, and C6. A C-state at a higher level has a wider range of components to be suspended at the time of its execution, and thus, more effective power saving is realized. The state of a computer in which a C-state has not been executed and power saving has not been realized is called C0.

FIGS. 16 through 18 show examples of execution of a C-state. FIG. 16 is a block diagram showing an example configuration of a processor. As shown in FIG. 16, a processor 10 includes an L1 cache memory (hereinafter referred to as the L1 cache) 11, a floating-point unit (FPU) 12, an L2 cache memory (hereinafter referred to as the L2 cache) 13, an arithmetic and logic unit (ALU) 14, and a register 15. That is, the processor 10 is formed with components having various functions.

It should be noted that each component shown in FIG. 16 is not necessarily provided in the processor 10. Further, the processor 10 may be a processor that includes a component of a type other than the components shown in FIG. 16.

FIG. 17 is a block diagram showing an example of execution of a C-state at C1. Unlike those in the processor 10 shown in FIG. 16, the FPU 12 and the ALU 14 shown in FIG. 17 are shaded. Each shaded portion in FIG. 17 means that the functions of the corresponding component have been suspended due to execution of a C-state. That is, FIG. 17 shows that the processor 10 is in a state in which the functions of the FPU 12 and the ALU 14 have been suspended.

FIG. 18 is a block diagram showing an example of execution of a C-state at C3. Unlike those in the processor 10 shown in FIG. 17, the L1 cache 11 and the register 15 shown in FIG. 18 are also shaded. That is, FIG. 18 shows that the processor 10 is in a state in which the functions of the L1 cache 11 and the register 15 have also been suspended.

As described above, a C-state is a function for realizing power saving in a processor by suspending the functions of the components of the processor in a stepwise manner. Japanese Patent No. 5730999 discloses an example of a device that controls a C-state. The device disclosed in Japanese Patent No. 5730999 has a C-state control function, and determines a C-state level, taking into account the tolerable delay value in processing.

When a C-state is executed, some of the functions of a computer are suspended. That is, when a C-state is executed, part of the operation of a computer is suspended for a predetermined time. Further, the wider the range of the components whose functions are to be suspended, the longer the transition time to a power saving state and the return time from the power saving state. Furthermore, during the transition to the power saving state and the returning from the power saving state, the application running on the computer completely stops its operation.

FIG. 19 is an explanatory diagram showing examples of the transition times, the return times, and the power usage rates in a case where a C-state is executed at the respective levels. As shown in FIG. 19, when a C-state at a higher level is executed, both the transition time and return time are longer. The power usage rate relative to C0 is lower.

In a case where software or a system that will obviously deteriorate in performance due to the delay time caused by execution of a C-state is operated in a computer, the only means to prevent degradation of software or system performance is to suspend the C-state and the other power saving functions.

For example, in an application whose performance is affected by a delay time, performance degradation caused by execution of a C-state at a higher level that is not suitable for the application becomes a serious problem. Therefore, in technical fields where a delay time in a network system or the like becomes an important factor, the functions of a C-state are often suspended to prioritize performance over power consumption.

### SUMMARY

An exemplary object of the invention is to provide a power consumption reduction device, a power consumption reduction method, and a power consumption reduction program that are capable of determining a C-state level at which application performance is not degraded.

A power consumption reduction device according to the present invention is a power consumption reduction device in which an application is operated, and includes: a processor; an output unit that is controlled by the processor in a user mode, and outputs a condition under which performance of the application is not degraded; and a determining unit that is controlled by the processor in a kernel mode, and determines a component to be operated among the components of the processor so that the output condition is satisfied.

A power consumption reduction device according to the present invention is a power consumption reduction device in which an application is operated, and includes: a processor; a determining unit that is controlled by the processor in a user mode, and determines a component to be operated among the components of the processor so that performance of the application is not degraded; and an instructing unit that is controlled by the processor in a kernel mode, and instructs the processor to operate only the determined component.

A power consumption reduction method according to the present invention is a power consumption reduction method that is implemented in a power consumption reduction device including a processor, an application being operated in the power consumption reduction device. The power consumption reduction method includes: outputting a condition under which performance of the application is not degraded, the processor in a user mode outputting the condition; and determining a component to be operated among the components of the processor so that the output condition is satisfied, the processor in a kernel mode determining the component.

A non-transitory computer-readable recording medium storing a power consumption reduction program according to the present invention. The power consumption reduction program is executed by a processor in a computer in which an application is operated, and causes the processor to: output a condition under which performance of the application is not degraded in a user mode; and determine a component to be operated among the components of the processor so that the output condition is satisfied in a kernel mode.

### BRIEF DESCRIPTION OF THE DRAWINGS

FIG. 1 is a block diagram showing an example configuration of a power consumption reduction device according to a first exemplary embodiment of the present invention;

FIG. 2 is a flowchart showing an operation in a determination process to be performed by a power consumption reduction device according to the first exemplary embodiment;

FIG. 3 is a block diagram showing another example configuration of a power consumption reduction device according to the first exemplary embodiment of the present invention;

FIG. 4 is a flowchart showing the operation in an instruction process to be performed by a power consumption reduction device according to the first exemplary embodiment;

FIG. 5 is a block diagram showing an example configuration of a computer according to a second exemplary embodiment of the present invention;

FIG. 6 is a block diagram showing a specific example of a computer according to the second exemplary embodiment;

FIG. 7 is a block diagram showing another specific example of a computer according to the second exemplary embodiment;

FIG. 8 is a flowchart showing the overall operation in a C-state control process to be performed by a computer according to the second exemplary embodiment;

FIG. 9 is a flowchart showing the operation in a computation process to be performed by the computer according to the second exemplary embodiment;

FIG. 10 is a flowchart showing the operation in a control process to be performed by the computer according to the second exemplary embodiment;

FIG. 11 is a block diagram showing an example configuration of a computer according to a third exemplary embodiment of the present invention;

FIG. 12 is a flowchart showing the operation in a C-state determination process to be performed by an application according to the third exemplary embodiment;

FIG. 13 is a flowchart showing the operation in a C-state control process to be performed by an OS/C-state control unit according to the third exemplary embodiment;

FIG. 14 is a block diagram showing an example configuration of a computer according to a fourth exemplary embodiment of the present invention;

FIG. 15 is a block diagram showing an example configuration of an environment for measuring a delay time caused by an L-state;

FIG. 16 is a block diagram showing an example configuration of a processor;

FIG. 17 is a block diagram showing an example of execution of a C-state at C1;

FIG. 18 is a block diagram showing an example of execution of a C-state at C3;

FIG. 19 is an explanatory diagram showing examples of transition times, return times, and power usage rates in a case where a C-state is executed at the respective levels; and

FIG. 20 is a block diagram showing an example configuration of a general computer in which a C-state is executed.

### DESCRIPTION OF EXEMPLARY EMBODIMENT

### First Exemplary Embodiment

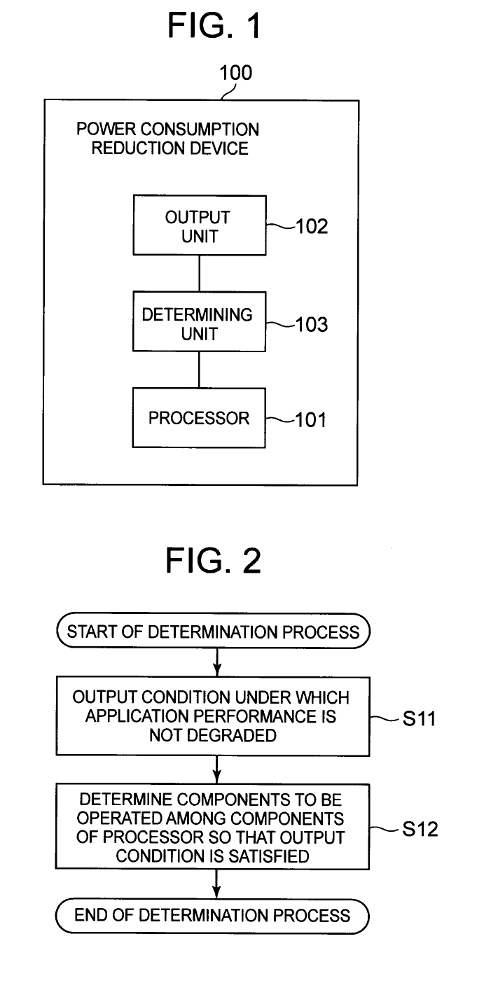

The following is a description of exemplary embodiments of the present invention, with reference to the accompanying drawings. FIG. 1 is a block diagram showing an example configuration of a power consumption reduction device according to a first exemplary embodiment of the present invention. A power consumption reduction device 100 according to the present invention is a power consumption reduction device in which an application is operated, and includes a processor 101 (a processor 1230, for example), an output unit 102 (a C-state control information output unit 1110, for example) that is controlled by the processor 101 in a user mode and outputs a condition under which the performance of the application is not degraded, and a determining unit 103 (an OS/C-state control unit 1200, for example) that is controlled by the processor 101 in a kernel mode and determines the components to be operated among the components of the processor 101 so that the output condition is satisfied.

A determination process to be performed by the power consumption reduction device 100 is now described. FIG. 2 is a flowchart showing the operation in a determination process to be performed by the power consumption reduction device 100 according to the first exemplary embodiment.

First, the output unit 102 under the control of the processor 101 in the user mode outputs a condition under which application performance is not degraded (step S11).

The determining unit 103 under the control of the processor 101 in the kernel mode then determines the components to be operated among the components of the processor 101 so that the output condition is satisfied (step S12). After the determination, the power consumption reduction device 100 ends the determination process.

With such a configuration, the power consumption reduction device can determine a C-state level at which application performance is not degraded.

The power consumption reduction device 100 may also include an instructing unit (the OS/C-state control unit 1200, for example) that is controlled by the processor 101 in the kernel mode and instructs the processor 101 to operate only the determined components.

With such a configuration, the power consumption reduction device can reduce power consumption of the processor so that application performance is not degraded.

Alternatively, as the condition under which application performance is not degraded, the output unit 102 may output such a maximum process delay time that performance is not degraded when the process being performed by the application is delayed.

With such a configuration, the power consumption reduction device can determine a C-state level, taking into account the tolerable delay time in a process according to an application.

Further, two or more applications may be operated in the power consumption reduction device 100, the output unit 102 may output, for the respective applications, conditions under which the performance of the respective applications is not degraded, and the determining unit 103 may determine the components to be operated among the components of the processor 101 so that the output conditions are satisfied.

With such a configuration, the power consumption reduction device can determine a C-state level at which the performance of the applications is not degraded.

The power consumption reduction device 100 may further include a PCI Express (registered trademark) device (a PCI Express device 2300, for example), and the determining unit 103 determines the components to be operated among the components of the PCI Express device so that the output condition is satisfied.

With such a configuration, the power consumption reduction device can reduce power consumption of the PCI Express device so that application performance is not degraded.

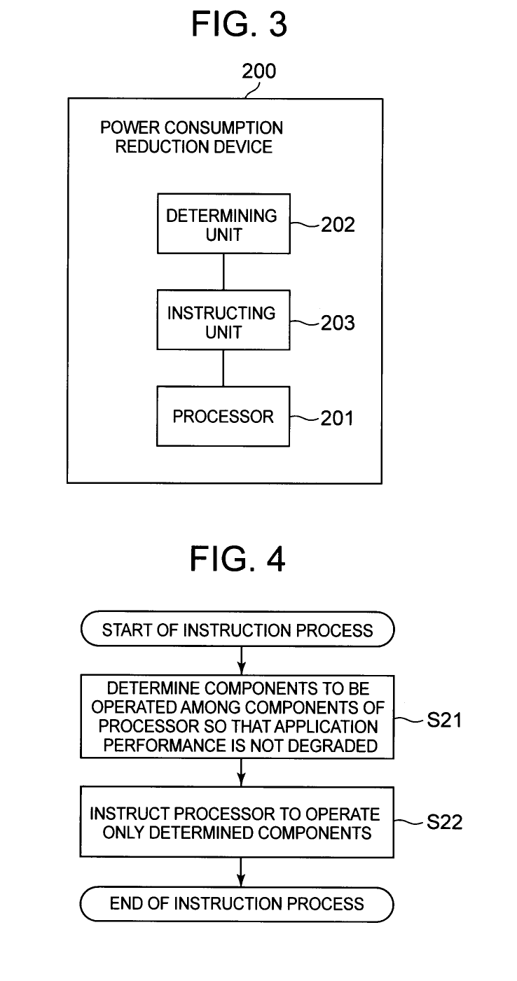

FIG. 3 is a block diagram showing another example configuration of a power consumption reduction device according to the first exemplary embodiment of the present invention. A power consumption reduction device 200 according to the present invention is a power consumption reduction device in which an application is operated, and includes a processor 201 (the processor 1230, for example), a determining unit 202 (a C-state determining unit 1130, for example) that is controlled by the processor 201 in a user mode and determines the components to be operated among the components of the processor 201 so that the performance of the application is not degraded, and an instructing unit 203 (the OS/C-state control unit 1200, for example) that is controlled by the processor 201 in a kernel mode and instructs the processor 201 to operate only the determined components.

An instruction process to be performed by the power consumption reduction device 200 is now described. FIG. 4 is a flowchart showing the operation in an instruction process to be performed by the power consumption reduction device 200 according to the first exemplary embodiment.

First, the determining unit 202 under the control of the processor 201 in the user mode determines the components to be operated among the components of the processor 201 so that application performance is not degraded (step S21).

The instructing unit 203 under the control of the processor 201 in the kernel mode instructs the processor 201 to operate only the determined components (step S22). After the instruction, the power consumption reduction device 200 ends the instruction process.

With such a configuration, the power consumption reduction device can determine a C-state level at which application performance is not degraded.

### Second Exemplary Embodiment

[Description of a Configuration]

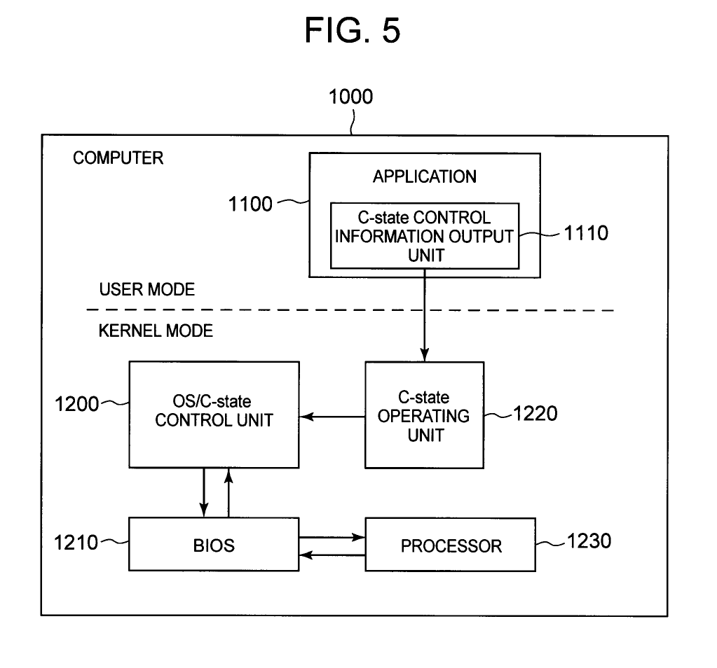

Next, a second exemplary embodiment of the present invention is described with reference to drawings. FIG. 5 is a block diagram showing an example configuration of a computer according to the second exemplary embodiment of the present invention.

A computer 1000 shown in FIG. 5 includes an application 1100 that operates in a user mode. Further, the application 1100 includes a C-state control information output unit 1110.

The computer 1000 shown in FIG. 5 also includes an OS/C-state control unit 1200, a basic input/output system (BIOS) 1210, and a C-state operating unit 1220 that operate in a kernel mode. The computer 1000 also includes a processor 1230.

Unlike the computer 9000 shown in FIG. 20, the computer 1000 of this exemplary embodiment includes the C-state control information output unit 1110 and the C-state operating unit 1220. As shown in FIG. 5, the C-state control information output unit 1110 is provided in the application 1100. Further, the C-state operating unit 1220 to which C-state control information is input is provided in the operating system (OS) of the computer 1000.

With the configuration shown in FIG. 5, the application 1100 can set, in the OS, information for performing C-state control on the OS. The OS can execute an appropriate C-state for the application 1100 by performing C-state control using the set information.

The C-state control information output unit 1110 of the application 1100 inputs the C-state control information to the C-state operating unit 1220. The C-state operating unit 1220 then inputs the input C-state control information to the OS/C-state control unit 1200.

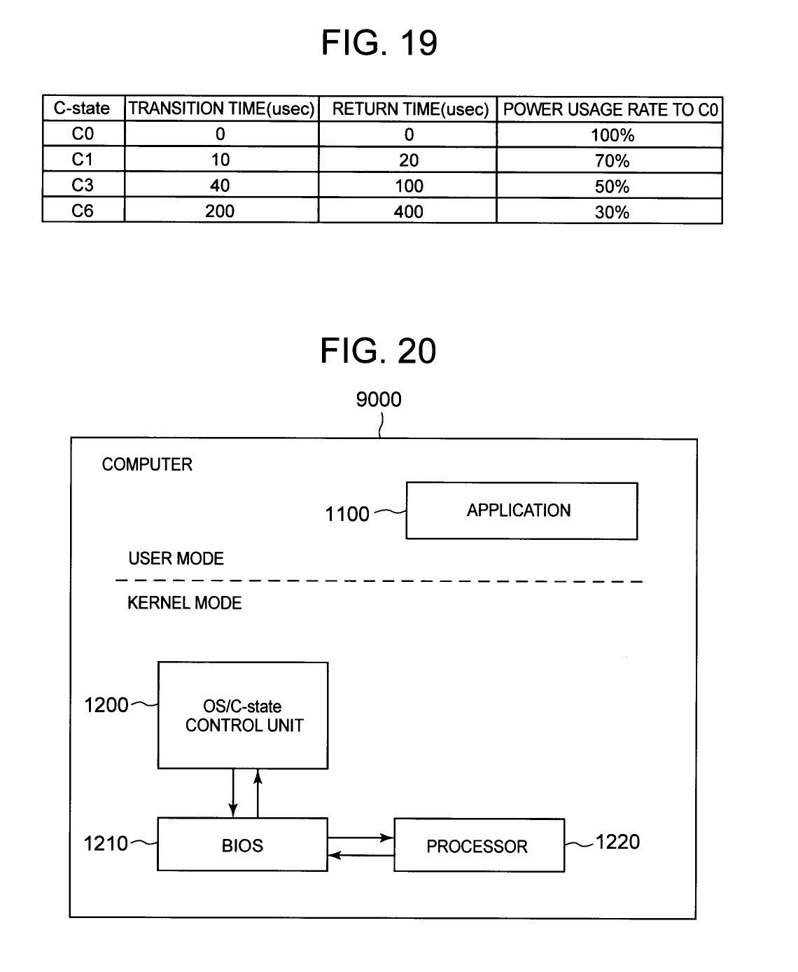

Using the input C-state control information, the OS/C-state control unit 1200 determines an appropriate C-state level. The information input to the C-state operating unit 1220 relates to the information shown in FIG. 19, for example.

The information shown in FIG. 19 is also constraint conditions for properly executing a C-state at the respective levels. The constraint conditions shown in FIG. 19 are conditions unique to each processor. The constraint conditions are acquired through issuance of an instruction unique to a processor, such as an advanced configuration and power interface (ACPI).

Alternatively, the constraint conditions may be incorporated into the OS in advance. If the constraint conditions are incorporated into the OS in advance, the C-state operating unit 1220 can acquire and use the constraint conditions. The OS/C-state control unit 1200 and the like according to this exemplary embodiment control a C-state, using the constraint conditions for the C-state.

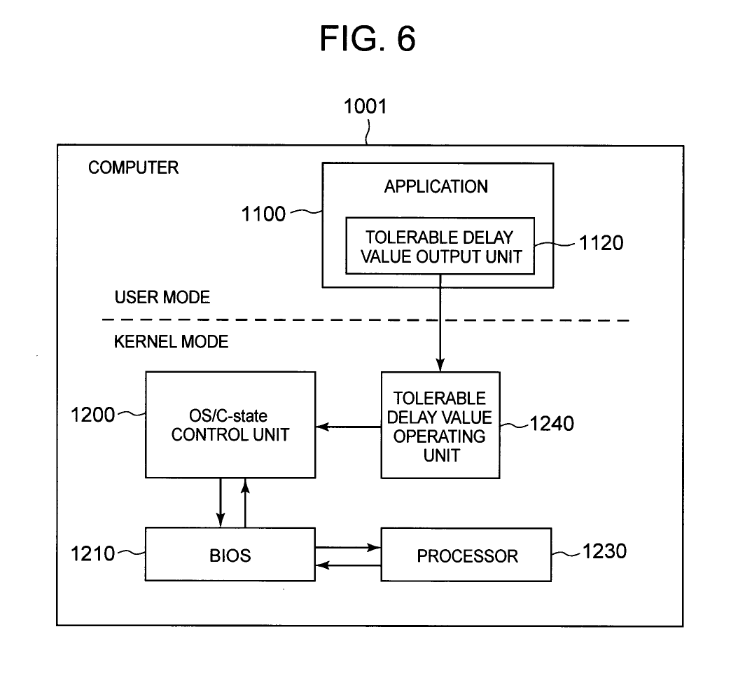

FIG. 6 is a block diagram showing a specific example of a computer according to the second exemplary embodiment. The specific example shown in FIG. 6 is an example in which one application sets a tolerable delay value in the OS to perform C-state control.

A computer 1001 shown in FIG. 6 includes an application 1100 that operates in a user mode. The application 1100 also includes a tolerable delay value output unit 1120.

The computer 1001 shown in FIG. 6 also includes an OS/C-state control unit 1200, a BIOS 1210, and a tolerable delay value operating unit 1240 that operate in a kernel mode. The computer 1001 further includes a processor 1230.

The application 1100 shown in FIG. 6 has a tolerable delay value that is the tolerable value of a delay time to be caused by execution of a C-state. The tolerable delay value output unit 1120 of this specific example inputs the tolerable delay value of the application 1100 to the tolerable delay value operating unit 1240. The tolerable delay value operating unit 1240 then inputs the input tolerable delay value to the OS/C-state control unit 1200.

Using the tolerable delay value input by the tolerable delay value operating unit 1240 and the constraint conditions for a C-state, the OS/C-state control unit 1200 selects the C-state level at which the delay time to be caused by execution of the C-state is the longest among the C-states having tolerable delay values equal to or shorter than the delay times to be caused by execution of the respective C-states.

It should be noted that the interrupts each serving as a delay trigger may include not only interrupts caused by an application or the OS but also interrupts caused by hardware.

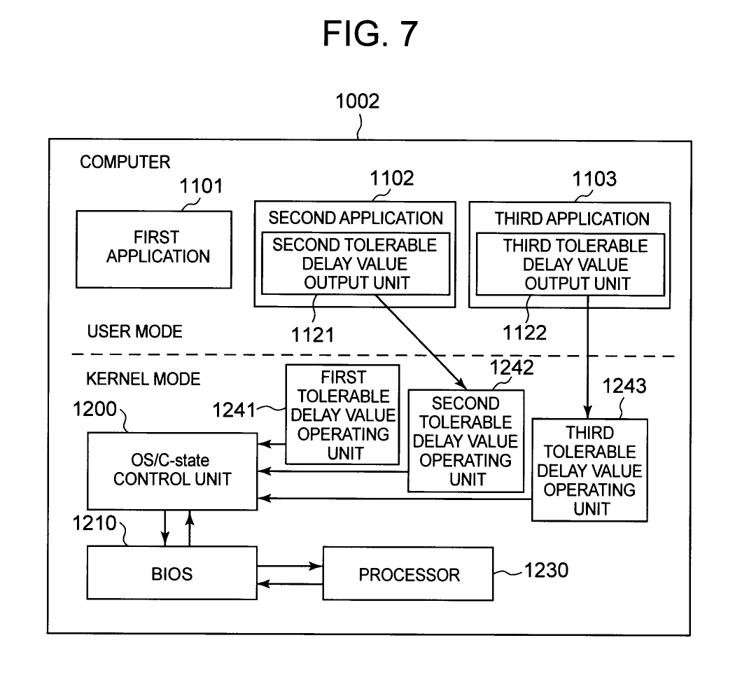

FIG. 7 is a block diagram showing another specific example of a computer according to the second exemplary embodiment. The specific example shown in FIG. 7 is an example in which two or more applications set tolerable delay values in the OS to perform C-state control.

A computer 1002 shown in FIG. 7 includes a first application 1101, a second application 1102, and a third application 1103 that operate in a user mode.

As shown in FIG. 7, the second application 1102 includes a second tolerable delay value output unit 1121. Likewise, the third application 1103 includes a third tolerable delay value output unit 1122.

The computer 1002 shown in FIG. 7 also includes an OS/C-state control unit 1200, a BIOS 1210, a first tolerable delay value operating unit 1241, a second tolerable delay value operating unit 1242, a third tolerable delay value operating unit 1243 that operate in kernel mode. The computer 1002 further includes a processor 1230. It should be noted that the specific example shown in FIG. 6 is one kind of the specific example shown in FIG. 7.

As shown in FIG. 7, in the computer 1002, there are applications each having a tolerable delay value. In the OS of the computer 1002, there are tolerable delay value operating units in which the tolerable delay values are set.

In the example shown in FIG. 7, the second tolerable delay value output unit 1121 of the second application 1102 inputs the tolerable delay value of the second application 1102 to the second tolerable delay value operating unit 1242. Likewise, the third tolerable delay value output unit 1122 of the third application 1103 inputs the tolerable delay value of the third application 1103 to the third tolerable delay value operating unit 1243.

[Description of Operation]

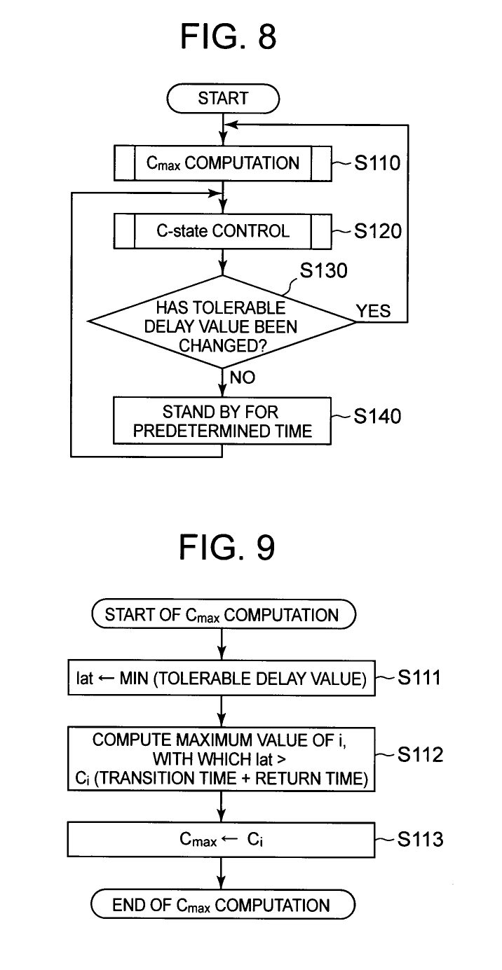

Referring now to FIGS. 8 through 10, operation of the computer 1002 of this exemplary embodiment is described.

Referring first to FIG. 8, an overall operation to be performed by the computer 1002 of this exemplary embodiment to perform C-state control is described. FIG. 8 is a flowchart showing the overall operation in a C-state control process to be performed by the computer 1002 according to the second exemplary embodiment.

First, the OS/C-state control unit 1200 computes Cₘₐₓ, which is Cᵢ having the largest i among Cᵢ indicating the C-state levels at which the sum of the transition time and the return time is shorter than the tolerable delay value (step S110).

The OS/C-state control unit 1200 then controls the C-state (step S120).

The OS/C-state control unit 1200 then checks whether the tolerable delay value has been changed (step S130). If the tolerable delay value has been changed (Yes in step S130), the OS/C-state control unit 1200 again performs the processing in step S110.

If the tolerable delay value has not been changed (No in step S130), the OS/C-state control unit 1200 stands by for a predetermined time (step S140). After standing by for the predetermined time, the OS/C-state control unit 1200 again performs the processing in step S120.

Referring now to FIG. 9, the operation to be performed by the computer 1002 to compute Cₘₐₓ, in step S110 is described. FIG. 9 is a flowchart showing the operation in a computation process to be performed by the computer 1002 according to the second exemplary embodiment.

The respective delay tolerance values are input to the OS/C-state control unit 1200 from the first tolerable delay value operating unit 1241, the second tolerable delay value operating unit 1242, and the third tolerable delay value operating unit 1243. The OS/C-state control unit 1200 sets the smallest value among the input tolerable delay values as “lat” (step S111).

The OS/C-state control unit 1200 then computes Cᵢ, which has the largest i among Cᵢ of the C-state levels at which the sum of the transition time and the return time is smaller than “lat” (step S112).

The OS/C-state control unit 1200 then sets Cᵢ computed in step S112 as Cₘₐₓ (step S113). After the setting, the computer 1002 ends the computation process.

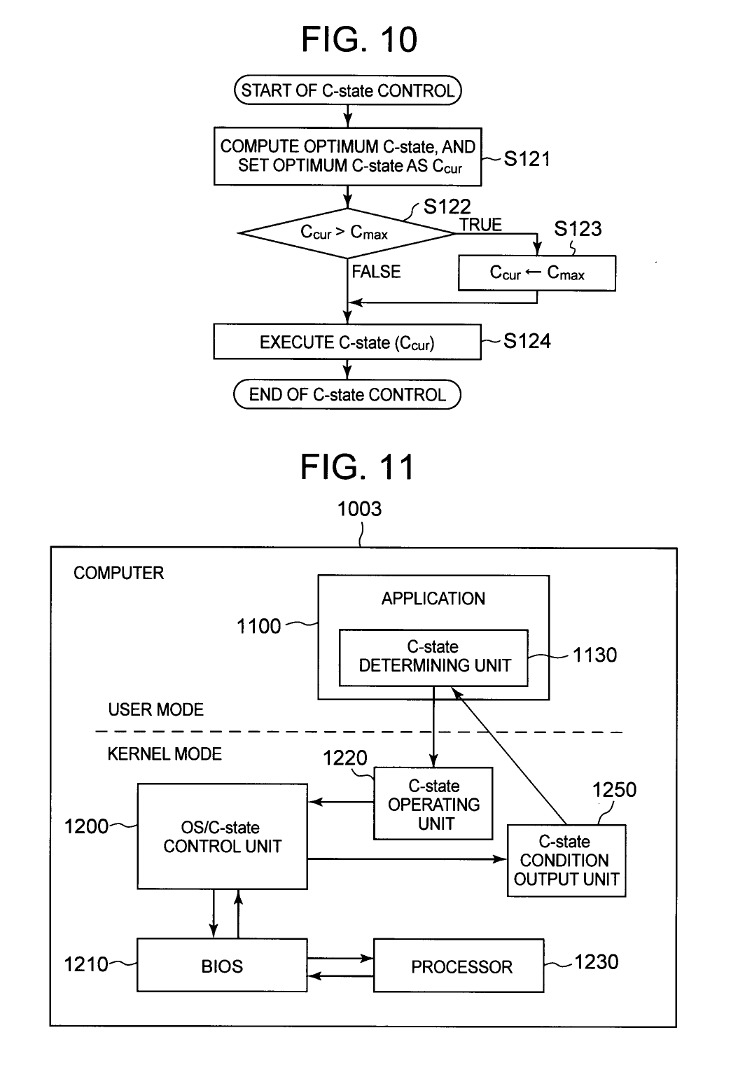

Referring now to FIG. 10, the operation to be performed by the computer 1002 to control the C-state in step S120 is described. FIG. 10 is a flowchart showing the operation in a control process to be performed by the computer 1002 according to the second exemplary embodiment.

First, the OS/C-state control unit 1200 computes an optimum C-state level. The OS/C-state control unit 1200 sets the computed C-state level as C_{cur} (step S121).

The OS/C-state control unit 1200 compares C_{cur} set in step S121 with Cₘₐₓ computed in step S110 (step S122). If C_{cur} is equal to or smaller than Cₘₐₓ (False in step S122), the OS/C-state control unit 1200 moves on to the processing in step S124.

If C_{cur} is greater than Cₘₐₓ (True in step S122), the OS/C-state control unit 1200 sets Cₘₐₓ as C_{cur} (step S123). After the setting, the OS/C-state control unit 1200 moves on to the processing in step S124.

The OS/C-state control unit 1200 then executes the C-state at C_{cur} (step S124). After the execution, the computer 1002 ends the control process.

That is, when determining the C-state level that satisfies the respective constraint conditions in the C-state control process shown in FIG. 8, the OS/C-state control unit 1200 computes the highest C-state level that satisfies all the tolerable delay values set by the respective applications.

The OS/C-state control unit 1200 performs computation processes at predetermined time intervals, for example. That is, the OS/C-state control unit 1200 repeatedly performs an optimum C-state computation process.

[Description of Effects]

An application that is a program operating in the user mode in a computer of this exemplary embodiment is provided with an output unit that outputs information for performing C-state control. Further, the basic program called the kernel or the OS for controlling the computer is provided with an operating unit capable of performing C-state control.

A program that operates in the user mode is required to include a component that outputs a tolerable delay value indicating the delay time allowed for a C-state to cause, and information for performing C-state control. An appropriate application that is a user mode program designates a C-state control method in the basic program called the kernel or the OS for controlling the computer.

In a case where a delay time is caused by execution of a C-state in a computer, performance degradation occurs if an application whose performance is affected by the delay time is running on the computer.

The computer of this exemplary embodiment is designed to be able to set a C-state within such a range that application performance is not affected. That is, where the computer of this exemplary embodiment is used, C-state control to minimize the influence on performance can be performed.

The computer of this exemplary embodiment can reduce the influence of performance degradation due to execution of a power saving function more effectively than the computer shown in FIG. 20.

The computer of this exemplary embodiment is particularly effective when used as a server computer that performs computation processes via computers.

The reason for this is that, in a desktop computer or a notebook computer that is used by an individual, a unit time that can be perceived by human beings is sufficiently longer than a delay time that is caused by execution of a C-state and is required for returning to the normal state. In other words, even if a C-state is executed, it is unlikely that trouble will be caused in an operation being performed in the computer.

However, a server computer operates in synchronization with a large number of computers. Therefore, the delay time that is caused by execution of a C-state and is required for returning to the normal state might have greater influence on computation processes than a computer that is used by an individual.

### Third Exemplary Embodiment

[Description of a Configuration]

Next, a third exemplary embodiment of the present invention is described with reference to drawings. FIG. 11 is a block diagram showing an example configuration of a computer according to the third exemplary embodiment of the present invention. The example shown in FIG. 11 is an example in which an application operates a C-state and controls the C-state.

A computer 1003 shown in FIG. 11 includes an application 1100 that operates in a user mode. The application 1100 includes a C-state determining unit 1130.

The computer 1003 shown in FIG. 11 includes an OS/C-state control unit 1200, a BIOS 1210, a C-state operating unit 1220, and a C-state condition output unit 1250 that operate in a kernel mode. The computer 1003 further includes a processor 1230.

As shown in FIG. 11, the C-state condition output unit 1250 is added to the OS. The C-state condition output unit 1250 inputs constraint conditions like those shown in FIG. 19 to the application 1100.

In some applications, the time or the timing at which operation may be suspended is known in advance. The C-state determining unit 1130 of the application 1100 of this exemplary embodiment determines the C-state level for the next transition target, using the known time at which operation may be suspended and the input constraint conditions.

After the determination, the C-state determining unit 1130 inputs transition information indicating the determined C-state level for the transition target to the C-state operating unit 1220. After the transition information is input to the C-state operating unit 1220, the OS/C-state control unit 1200 immediately executes the C-state at the level indicated by the input transition information.

[Description of Operation]

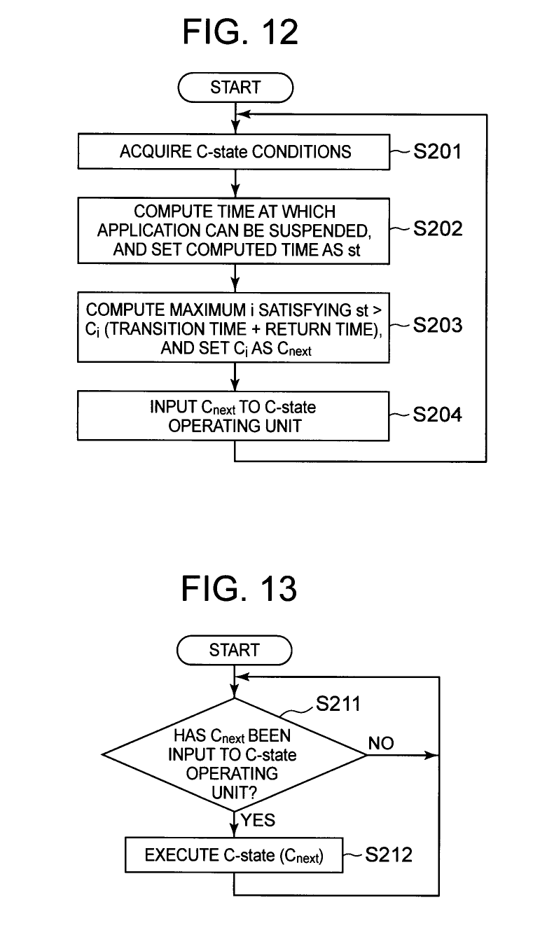

Referring now to FIGS. 12 and 13, operation of the computer 1003 of this exemplary embodiment is described.

Referring first to FIG. 12, an operation to be performed by the application 1100 of this exemplary embodiment to determine a C-state level is described. FIG. 12 is a flowchart showing the operation in a C-state determination process to be performed by the application 1100 according to the third exemplary embodiment.

First, the C-state determining unit 1130 of the application 1100 acquires C-state constraint conditions from the C-state condition output unit 1250 (step S201).

The C-state determining unit 1130 then computes the time at which the application 1100 can be stopped. The C-state determining unit 1130 sets the computed time as “st” (step S202).

The C-state determining unit 1130 then computes Cᵢ, which has the largest i among Cᵢ of the C-state levels at which the sum of the transition time and the return time is smaller than “st”. The C-state determining unit 1130 sets the computed Cᵢ as Cₙₑₓₜ (step S203).

The OS/C-state control unit 1200 then inputs Cₙₑₓₜ to the C-state operating unit 1220 (step S204). After the input, the application 1100 again performs the processing in step S201.

As described above, the application 1100 computes an optimum C-state for the application 1100. The optimal C-state is computed by taking into account not only C-state levels such as C1, C3, and C6, but also C-state execution frequency. The application 1100 sets the value indicating the C-state level in the C-state operating unit 1220 of the OS at the timing when the C-state should be executed.

Referring now to FIG. 13, the operation to be performed by the OS/C-state control unit 1200 of this exemplary embodiment to control a C-state is described. FIG. 13 is a flowchart showing the operation in a C-state control process to be performed by the OS/C-state control unit 1200 according to the third exemplary embodiment.

First, the OS/C-state control unit 1200 checks whether Cₙₑₓₜ has been input to the C-state operating unit 1220 (step S211). If Cₙₑₓₜ has not been input (No in step S211), the OS/C-state control unit 1200 stands by until Cₙₑₓₜ is input.

If Cₙₑₓₜ has been input (Yes in step S211), the OS/C-state control unit 1200 executes the C-state at Cₙₑₓₜ (step S212). After the execution, the OS/C-state control unit 1200 again performs the processing in step S211.

As described above, the OS/C-state control unit 1200 of the computer 1003 monitors whether a value indicating a C-state level is set in the C-state operating unit 1220 from the application 1100. After the value is set in the C-state operating unit 1220, the OS/C-state control unit 1200 immediately executes the C-state at the level indicated by the set value.

[Description of Effects]

Where the computer of this exemplary embodiment is used, the C-state determining unit 1130 performs appropriate power saving control, so that power saving that does not degrade application performance can be realized even in a system that executes an application whose performance is affected by a delay.

### Fourth Exemplary Embodiment

[Description of a Configuration]

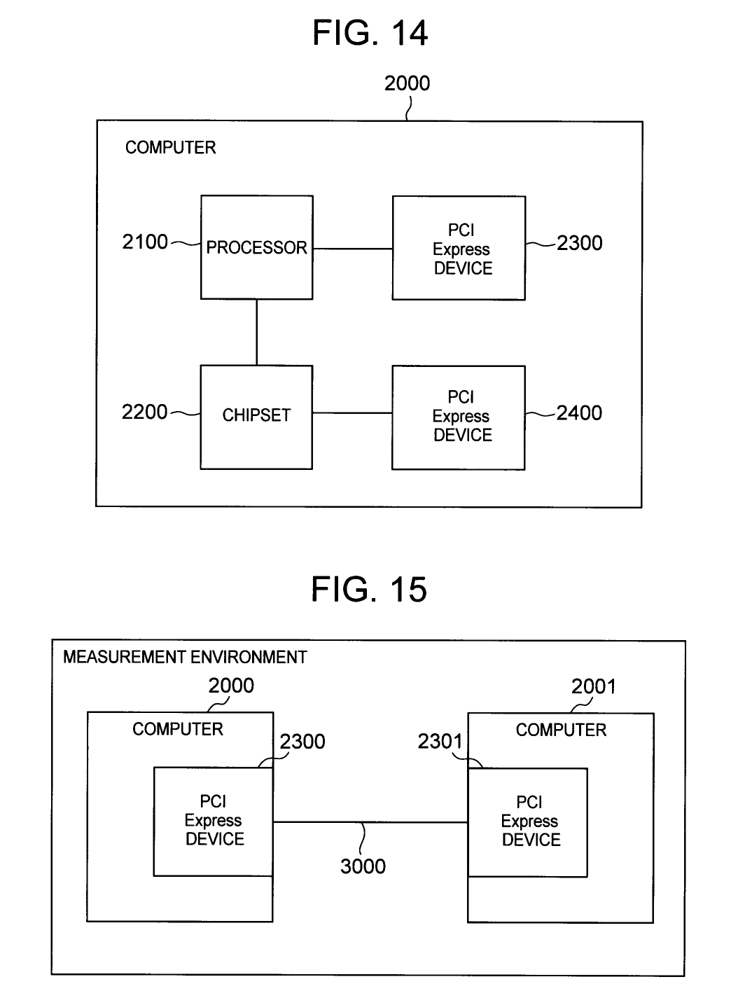

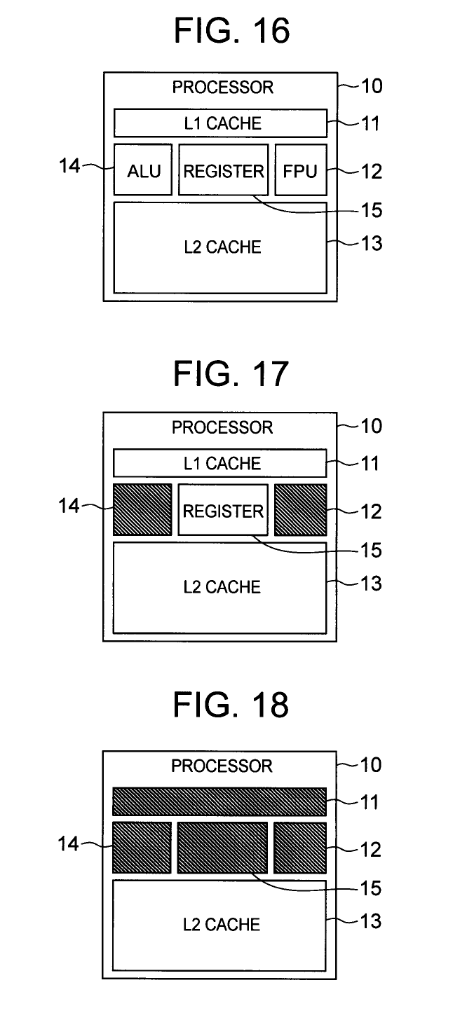

Next, a fourth exemplary embodiment of the present invention is described with reference to drawings. FIG. 14 is a block diagram showing an example configuration of a computer according to the fourth exemplary embodiment of the present invention. The configuration shown in FIG. 14 is the configuration of a computer that performs L-state control.

The technology of the second exemplary embodiment or the technology of the third exemplary embodiment can also be applied to a function for realizing power saving of some other component of a computer besides a C-state that is a function for realizing power saving of a processor.

This exemplary embodiment concerns application of the technology of the second exemplary embodiment or the technology of the third exemplary embodiment to an L-state that is a function for realizing power saving of a PCI Express that is a general-purpose interface. Like a C-state, an L-state is a function for realizing power saving by suspending operation of a PCI Express interface of a computer or operation of a PCI Express device of the connection destination.

In this exemplary embodiment, application to a computer shown in FIG. 14 is considered. The computer 2000 shown in FIG. 14 includes a processor 2100, a chipset 2200, a PCI Express device 2300, and a PCI Express device 2400. The method of connecting the PCI Express device 2300 and the PCI Express device 2400 in the computer 2000 is not limited to any specific method.

The delay time to be caused when the PCI Express device 2300 and the PCI Express device 2400 are stopped by an L-state has an unknown value. Therefore, a delay time caused by an L-state in a measurement environment shown in FIG. 15 is measured.

FIG. 15 is a block diagram showing an example configuration of an environment for measuring a delay time caused by an L-state. As shown in FIG. 15, the measurement environment is formed with a computer 2000 and a computer 2001. The computer 2000 operates an L-state. The computer 2001 measures the delay time due to the L-state in a process performed by the computer 2000.

The computer 2000 includes a PCI Express device 2300. Likewise, the computer 2001 includes a PCI Express device 2301. In the measurement environment shown in FIG. 15, the PCI Express device 2300 and the PCI Express device 2301 are assumed to be network devices.

As shown in FIG. 15, the PCI Express device 2300 is communicably connected to the PCI Express device 2301 by a network cable 3000. That is, the PCI Express device 2300 can communicate with the PCI Express device 2301.

The computer 2000 changes the L-state provided in the computer in a stepwise manner from L0 to L1 to L2, for example. The computer 2001 measures the delay times caused by the L-state at the respective levels. In accordance with the measured information, the computer 2001 generates L-state constraint conditions corresponding to the constraint conditions shown in FIG. 19.

The computer 2001 then transmits the generated L-state constraint conditions to the computer 2000. Through the above process, the computer 2000 can determine the L-state constraint conditions. In accordance with the determined constraint conditions, the computer 2000 can control the power saving function of the L-state in the same manner as the control of the power saving function of a C-state, using the OS and an application.

The computer of each exemplary embodiment is expected to be suitably used as a server computer, a personal computer, a portable computer, or a network device such as a router or a hub. Restrictions are imposed on exhaust heat quantities and power consumption of such computers and network devices. That is, the computer of each exemplary embodiment may be used not only as a server computer but also as a desktop computer or a notebook computer that is used by an individual.

The unidirectional arrows shown in the respective block diagrams indicate directions in which data flows. However, there remains a possibility of data flowing bidirectionally at the portions indicated by the arrows.

Furthermore, some or all of the above exemplary embodiments can also be described as noted below, but are not limited to the following configurations.

### Supplementary Note 1

A power consumption reduction device in which an application is operated,
the power consumption reduction device including:
a processor;
an output unit that is controlled by the processor in a user mode, and outputs a condition under which performance of the application is not degraded; and
a determining unit that is controlled by the processor in a kernel mode, and determines a component to be operated among components of the processor so that the output condition is satisfied.

### Supplementary Note 2

The power consumption reduction device according to supplementary note 1, further including
an instructing unit that is controlled by the processor in the kernel mode, and instructs the processor to operate only the determined component.

### Supplementary Note 3

The power consumption reduction device according to supplementary note 1, wherein the output unit outputs a maximum delay time when processing by the application is delayed, the maximum delay time of the processing being output as a condition under which performance of the application is not degraded, the maximum delay time not degrading the performance.

### Supplementary Note 4

The power consumption reduction device according to supplementary note 2, wherein the output unit outputs a maximum delay time when processing by the application is delayed, the maximum delay time of the processing being output as a condition under which performance of the application is not degraded, the maximum delay time not degrading the performance.

### Supplementary Note 5

The power consumption reduction device according to supplementary note 1, wherein
a plurality of applications are operated,
the output unit outputs, for the respective applications, conditions under which performance of the respective applications is not degraded, and
the determining unit determines a component to be operated among the components of the processor so that the output conditions are satisfied.

### Supplementary Note 6

The power consumption reduction device according to supplementary note 2, wherein
a plurality of applications are operated,
the output unit outputs, for the respective applications, conditions under which performance of the respective applications is not degraded, and
the determining unit determines a component to be operated among the components of the processor so that the output conditions are satisfied.

### Supplementary Note 7

The power consumption reduction device according to supplementary note 3, wherein
a plurality of applications are operated,
the output unit outputs, for the respective applications, conditions under which performance of the respective applications is not degraded, and
the determining unit determines a component to be operated among the components of the processor so that the output conditions are satisfied.

### Supplementary Note 8

The power consumption reduction device according to supplementary note 4, wherein
a plurality of applications are operated,
the output unit outputs, for the respective applications, conditions under which performance of the respective applications is not degraded, and
the determining unit determines a component to be operated among the components of the processor so that the output conditions are satisfied.

### Supplementary Note 9

The power consumption reduction device according to supplementary note 1, further including
a PCI Express device,
wherein the determining unit determines a component to be operated among components of the PCI Express device so that the output condition is satisfied.

### Supplementary Note 10

The power consumption reduction device according to supplementary note 2, further including
a PCI Express device,
wherein the determining unit determines a component to be operated among components of the PCI Express device so that the output condition is satisfied.

### Supplementary Note 11

The power consumption reduction device according to supplementary note 3, further including
a PCI Express device,
wherein the determining unit determines a component to be operated among components of the PCI Express device so that the output condition is satisfied.

### Supplementary Note 12

The power consumption reduction device according to supplementary note 4, further including
a PCI Express device,
wherein the determining unit determines a component to be operated among components of the PCI Express device so that the output condition is satisfied.

### Supplementary Note 13

The power consumption reduction device according to supplementary note 5, further including
a PCI Express device,
wherein the determining unit determines a component to be operated among components of the PCI Express device so that the output conditions are satisfied.

### Supplementary Note 14

The power consumption reduction device according to supplementary note 6, further including
a PCI Express device,
wherein the determining unit determines a component to be operated among components of the PCI Express device so that the output conditions are satisfied.

### Supplementary Note 15

The power consumption reduction device according to supplementary note 7, further including
a PCI Express device,
wherein the determining unit determines a component to be operated among components of the PCI Express device so that the output conditions are satisfied.

### Supplementary Note 16

The power consumption reduction device according to supplementary note 8, further including
a PCI Express device,
wherein the determining unit determines a component to be operated among components of the PCI Express device so that the output conditions are satisfied.

### Supplementary Note 17

A power consumption reduction method implemented in a power consumption reduction device including a processor, an application being operated in the power consumption reduction device,
the power consumption reduction method including:
outputting a condition under which performance of the application is not degraded, the processor in a user mode outputting the condition; and
determining a component to be operated among components of the processor so that the output condition is satisfied, the processor in a kernel mode determining the component.

### Supplementary Note 18

The power consumption reduction method according to supplementary note 17, wherein the processor operates only the determined component.

### Supplementary Note 19

A non-transitory computer-readable recording medium storing a power consumption reduction program to be executed by a processor in a computer in which an application is operated,
the power consumption reduction program causing the processor to:
output a condition under which performance of the application is not degraded in a user mode; and
determine a component to be operated among components of the processor so that the output condition is satisfied in a kernel mode.

### Supplementary Note 20

The recording medium according to supplementary note 19, wherein only the determined component is operated when the power consumption reduction program is executed by the processor.

### Supplementary Note 21

A power consumption reduction device in which an application is operated,
the power consumption reduction device including:
a processor;
a determining unit that is controlled by the processor in a user mode, and determines a component to be operated among components of the processor so that performance of the application is not degraded; and
an instructing unit that is controlled by the processor in a kernel mode, and instructs the processor to operate only the determined component.

### Supplementary Note 22

A power consumption reduction method implemented in a power consumption reduction device including a processor, an application being operated in the power consumption reduction device,
the power consumption reduction method including:
determining a component to be operated among components of the processor so that performance of the application is not degraded, the processor in a user mode determining the component; and
operating only the determined component, the processor in a kernel mode operating only the determined component.

### Supplementary Note 23

A non-transitory computer-readable recording medium storing a power consumption reduction program to be executed by a processor in a computer in which an application is operated,
the power consumption reduction program causing the processor to:
determine a component to be operated among components of the processor so that performance of the application is not degraded in a user mode; and
operate only the determined component in a kernel mode.

To effectively use a C-state function, each application is required to be involved in controlling the C-state so that performance is not degraded. However, in a general computer in which a C-state is executed, any application is not involved in controlling the C-state. An example of a general computer in which a C-state is executed is now described.

FIG. 20 is a block diagram showing an example configuration of a general computer in which a C-state is executed. A computer 9000 shown in FIG. 20 includes an application 1100 that operates in a user mode.

The computer 9000 also includes an OS/C-state control unit 1200 and a BIOS 1210 that operate in a kernel mode. The OS of the computer is formed with components that operate in the kernel mode. The computer 9000 further includes a processor 1230.

In the computer 9000 shown in FIG. 20, the C-state is controlled exclusively by the OS. That is, as shown in FIG. 20, the application 1100 is not involved in controlling the C-state.

To solve the above problem, there is a demand for a device in which an application can also be involved in controlling the C-state. Japanese Patent No. 5972981 discloses an example of a device in which an application can be involved in controlling the C-state.

Japanese Patent No. 5972981 discloses a device that has a C-state control function, and determines an optimum C-state level, using control information from an application.

However, Japanese Patent No. 5972981 does not disclose that the application side inputs a condition under which performance of the application is not degraded to the OS side, the condition being related to the constraint conditions for executing a C-state.

According to the present invention, it is possible to determine a C-state level at which application performance is not degraded.

While the invention has been particularly shown and described with reference to exemplary embodiments thereof, the invention is not limited to these embodiment. It will be understood by those of ordinary skill in the art that various changes in form and details may be made therein without departing from the spirit and scope of the present invention as defined by the claims.

What is claimed is:

1. A power consumption reduction device in which an application is operated,
the power consumption reduction device comprising:
a processor;
an output unit that is controlled by the processor in a user mode, and outputs a condition under which performance of the application is not degraded; and
a determining unit that is controlled by the processor in a kernel mode, and determines a component to be operated among components of the processor so that the output condition is satisfied.

2. The power consumption reduction device according to claim 1, further comprising
an instructing unit that is controlled by the processor in the kernel mode, and instructs the processor to operate only the determined component.

3. The power consumption reduction device according to claim 1, wherein the output unit outputs a maximum delay time when processing by the application is delayed, the maximum delay time of the processing being output as a condition under which performance of the application is not degraded, the maximum delay time not degrading the performance.

4. The power consumption reduction device according to claim 2, wherein the output unit outputs a maximum delay time when processing by the application is delayed, the maximum delay time of the processing being output as a condition under which performance of the application is not degraded, the maximum delay time not degrading the performance.

5. The power consumption reduction device according to claim 1, wherein
a plurality of applications are operated,
the output unit outputs, for the respective applications, conditions under which performance of the respective applications is not degraded, and
the determining unit determines a component to be operated among the components of the processor so that the output conditions are satisfied.

6. The power consumption reduction device according to claim 2, wherein
a plurality of applications are operated,
the output unit outputs, for the respective applications, conditions under which performance of the respective applications is not degraded, and
the determining unit determines a component to be operated among the components of the processor so that the output conditions are satisfied.

7. The power consumption reduction device according to claim 3, wherein
a plurality of applications are operated,
the output unit outputs, for the respective applications, conditions under which performance of the respective applications is not degraded, and
the determining unit determines a component to be operated among the components of the processor so that the output conditions are satisfied.

8. The power consumption reduction device according to claim 4, wherein
a plurality of applications are operated,
the output unit outputs, for the respective applications, conditions under which performance of the respective applications is not degraded, and
the determining unit determines a component to be operated among the components of the processor so that the output conditions are satisfied.

9. The power consumption reduction device according to claim 1, further comprising
a PCI Express device,
wherein the determining unit determines a component to be operated among components of the PCI Express device so that the output condition is satisfied.

10. The power consumption reduction device according to claim 2, further comprising
a PCI Express device,
wherein the determining unit determines a component to be operated among components of the PCI Express device so that the output condition is satisfied.

11. The power consumption reduction device according to claim 3, further comprising
a PCI Express device,
wherein the determining unit determines a component to be operated among components of the PCI Express device so that the output condition is satisfied.

12. The power consumption reduction device according to claim 4, further comprising
a PCI Express device,
wherein the determining unit determines a component to be operated among components of the PCI Express device so that the output condition is satisfied.

13. The power consumption reduction device according to claim 5, further comprising
a PCI Express device,
wherein the determining unit determines a component to be operated among components of the PCI Express device so that the output conditions are satisfied.

14. The power consumption reduction device according to claim 6, further comprising
a PCI Express device,
wherein the determining unit determines a component to be operated among components of the PCI Express device so that the output conditions are satisfied.

15. The power consumption reduction device according to claim 7, further comprising
a PCI Express device,
wherein the determining unit determines a component to be operated among components of the PCI Express device so that the output conditions are satisfied.

16. The power consumption reduction device according to claim 8, further comprising
a PCI Express device,
wherein the determining unit determines a component to be operated among components of the PCI Express device so that the output conditions are satisfied.

17. A power consumption reduction method implemented in a power consumption reduction device including a processor, an application being operated in the power consumption reduction device,
the power consumption reduction method comprising:
outputting a condition under which performance of the application is not degraded, the processor in a user mode outputting the condition; and
determining a component to be operated among components of the processor so that the output condition is satisfied, the processor in a kernel mode determining the component.

18. The power consumption reduction method according to claim 17, wherein the processor operates only the determined component.

19. A non-transitory computer-readable recording medium storing a power consumption reduction program to be executed by a processor in a computer in which an application is operated,
the power consumption reduction program causing the processor to:
output a condition under which performance of the application is not degraded in a user mode; and
determine a component to be operated among components of the processor so that the output condition is satisfied in a kernel mode.

20. The recording medium according to claim 19, wherein only the determined component is operated when the power consumption reduction program is executed by the processor.
